(19) United States
(12) Patent Application Publication
(10) Pub. No.: US 2022/0057936 A1
(43) Pub. Date: Feb. 24, 2022

(54) METHOD AND SYSTEM OF HOST RESOURCE CONSUMPTION REDUCTION FOR HOST-BASED DATA STORAGE

(71) Applicant: ALIBABA GROUP HOLDING LIMITED, George Town (KY)

(72) Inventor: Shu LI, Santa Clara, CA (US)

(21) Appl. No.: 16/996,111

(22) Filed: Aug. 18, 2020

(51) Int. Cl. G06F 3/06; G06F 16/13

(52) U.S. Cl. CPC G06F 3/064; G06F 16/137; G06F 3/0679; G06F 3/0647; G06F 3/0659; G06F 3/0613

(57) ABSTRACT

The present disclosure provides methods, systems, and non-transitory computer readable media for optimizing data storing. An exemplary method comprises: receiving a data request for storing data on a storage device, wherein the data request is received on a host that is communicatively coupled to the storage device; determining, by the host, a data bucket to store the data, wherein the data bucket comprises a plurality of data blocks in the storage device, and the plurality of data blocks belong to more than one channel in the storage device; and storing the data across the plurality of data blocks.

### TECHNICAL FIELD

The present disclosure generally relates to data storage, and more particularly, to methods, systems, and non-transitory computer readable media for optimizing performance of a host-based data storage system.

### BACKGROUND

All modern-day computers have some form of secondary storage for long-term storage of data. Traditionally, hard disk drives (“HDDs”) were used for this purpose, but computer systems are increasingly turning to solid-state drives (“SSDs”) as their secondary storage units. SSDs implement management firmware that is operated by microprocessors inside the SSDs for functions, performance, and reliability. While offering significant advantages over HDDs, the firmware mechanism of SSDs experience difficulties in meeting more demanding requirements on drive performance. Moreover, traditional SSD firmware performs like a black box, which is inconvenient and sometimes impossible for cloud service providers to perform system performance tuning for the SSDs.

### SUMMARY OF THE DISCLOSURE

Embodiments of the present disclosure provide a method for optimizing data storing. The method comprises: receiving a data request for storing data on a storage device, wherein the data request is received on a host that is communicatively coupled to the storage device; determining, by the host, a data bucket to store the data, wherein the data bucket comprises a plurality of data blocks in the storage device, and the plurality of data blocks belong to more than one channel in the storage device; and storing the data across the plurality of data blocks.

Embodiments of the present disclosure further provide a method for optimizing data access. The method comprises: receiving a data request for accessing data on a storage device, wherein the data request is received on a host that is communicatively coupled to the storage device; determining, by the host, a data bucket that stores the data, wherein the data bucket comprises a plurality of data blocks in the storage device, and the plurality of data blocks belong to more than one channel in the storage device; and accessing the data across the plurality of data blocks.

Embodiments of the present disclosure further provide a non-transitory computer readable medium that stores a set of instructions that is executable by at least one processor of a computer system to cause the computer system to perform a method, the method comprising: receiving a data request for storing data on a storage device, wherein the data request is received on a host that is communicatively coupled to the storage device; determining, by the host, a data bucket to store the data, wherein the data bucket comprises a plurality of data blocks in the storage device, and the plurality of data blocks belong to more than one channel in the storage device; and storing the data across the plurality of data blocks.

Embodiments of the present disclosure further provide a non-transitory computer readable medium that stores a set of instructions that is executable by at least one processor of a computer system to cause the computer system to perform a method, the method comprising: receiving a data request for accessing data on a storage device, wherein the data request is received on a host that is communicatively coupled to the storage device; determining, by the host, a data bucket that stores the data, wherein the data bucket comprises a plurality of data blocks in the storage device, and the plurality of data blocks belong to more than one channel in the storage device; and accessing the data across the plurality of data blocks.

Embodiments of the present disclosure further provide a system for optimizing data storage, comprising: a memory storing a set of instructions; one or more processors configured to execute the set of instructions to cause the system to perform: receiving a data request for storing data on a storage device, wherein the data request is received on a host that is communicatively coupled to the storage device; determining, by the host, a data bucket to store the data, wherein the data bucket comprises a plurality of data blocks in the storage device, and the plurality of data blocks belong to more than one channel in the storage device; and storing the data across the plurality of data blocks.

Embodiments of the present disclosure further provide a system for optimizing data storage, comprising: a memory storing a set of instructions; one or more processors configured to execute the set of instructions to cause the system to perform: receiving a data request for accessing data on a storage device, wherein the data request is received on a host that is communicatively coupled to the storage device; determining, by the host, a data bucket that stores the data, wherein the data bucket comprises a plurality of data blocks in the storage device, and the plurality of data blocks belong to more than one channel in the storage device; accessing the data across the plurality of data blocks.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is an example schematic illustrating a basic layout of an SSD, according to some embodiments of the present disclosure.

FIG. 2 is an illustration of an exemplary internal NAND flash structure of an SSD, according to some embodiments of the present disclosure.

FIG. 3 is an illustration of an exemplary host-based flash translation layer SSD with host resource utilization, according to some embodiments.

FIG. 4 is an illustration of an exemplary diagram of two-stage data placement, according to some embodiments of the present disclosure.

FIG. 5 is an illustration of an example diagram of multiple streams with data hotness, according to some embodiments of the present disclosure.

FIG. 6 is an illustration of an example diagram of multiple channels in an SSD, according to some embodiments of the present disclosure.

FIG. 7 is an illustration of an example diagram of a second stage of mapping, according to some embodiments of the present disclosure.

FIG. 8 is an illustration of an example diagram of a first stage and a second stage of file placement and access using hash functions, according to some embodiments of the present disclosure.

FIG. 9 illustrates a flowchart of an example method for storing data in a host-based SSD using two stage placements, according to some embodiments of the present disclosure.

FIG. 10 illustrates a flowchart of an example method for accessing data in a host-based SSD using two stage placements, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

Modern day computers are based on the Von Neuman architecture. As such, broadly speaking, the main components of a modern-day computer can be conceptualized as two components: something to process data, called a processing unit, and something to store data, called a primary storage unit. The processing unit (e.g., CPU) fetches instructions to be executed and data to be used from the primary storage unit (e.g., RAM), performs the requested calculations, and writes the data back to the primary storage unit. Thus, data is both fetched from and written to the primary storage unit, in some cases after every instruction cycle. This means that the speed at which the processing unit can read from and write to the primary storage unit can be important to system performance. Should the speed be insufficient, moving data back and form becomes a bottleneck on system performance. This bottleneck is called the Von Neumann bottleneck.

High speed and low latency are factors in choosing an appropriate technology to use in the primary storage unit. Modern day systems typically use DRAM. DRAM can transfer data at dozens of GB/s with latency of only a few nanoseconds. However, in maximizing speed and response time, there can be a tradeoff. DRAM has three drawbacks. DRAM has relatively low density in terms of amount of data stored, in both absolute and relative measures. DRAM has a much lower ratio of data per unit size than other storage technologies and would take up an unwieldy amount of space to meet current data storage needs. DRAM is also significantly more expensive than other storage media on a price per gigabyte basis. Finally, and most importantly, DRAM is volatile, which means it does not retain data if power is lost. Together, these three factors make DRAM not as suitable for long-term storage of data. These same limitations are shared by most other technologies that possess the speeds and latency needed for a primary storage device.

In addition to having a processing unit and a primary storage unit, modern-day computers also have a secondary storage unit. What differentiates primary and secondary storage is that the processing unit has direct access to data in the primary storage unit, but not necessarily the secondary storage unit. Rather, to access data in the secondary storage unit, the data from the second storage unit is first transferred to the primary storage unit. This forms a hierarchy of storage, where data is moved from the secondary storage unit (non-volatile, large capacity, high latency, low bandwidth) to the primary storage unit (volatile, small capacity, low latency, high bandwidth) to make the data available to process. The data is then transferred from the primary storage unit to the processor, perhaps several times, before the data is finally transferred back to the secondary storage unit. Thus, like the link between the processing unit and the primary storage unit, the speed and response time of the link between the primary storage unit and the secondary storage unit are also important factors to the overall system performance. Should its speed and responsiveness prove insufficient, moving data back and forth between the memory unit and secondary storage unit can also become a bottleneck on system performance.

Traditionally, the secondary storage unit in a computer system was HDD. HDDs are electromechanical devices, which store data by manipulating the magnetic field of small portions of a rapidly rotating disk composed of ferromagnetic material. But HDDs have several limitations that make them less favored in modern day systems. In particular, the transfer speeds of HDDs are largely stagnated. The transfer speed of an HDD is largely determined by the speed of the rotating disk, which begins to face physical limitations above a certain number of rotations per second (e.g., the rotating disk experiences mechanical failure and fragments). Having largely reached the current limits of angular velocity sustainable by the rotating disk, HDD speeds have mostly plateaued. However, CPU's processing speed did not face a similar limitation. As the amount of data accessed continued to increase, HDD speeds increasingly became a bottleneck on system performance. This led to the search for and eventually introduction of a new memory storage technology.

The storage technology ultimate chosen was flash memory. Flash storage is composed of circuitry, principally logic gates composed of transistors. Since flash storage stores data via circuitry, flash storage is a solid-state storage technology, a category for storage technology that doesn't have (mechanically) moving components. A solid-state based device has advantages over electromechanical devices such as HDDs, because solid-state devices does not face the physical limitations or increased chances of failure typically imposed by using mechanical movements. Flash storage is faster, more reliable, and more resistant to physical shock. As its cost-per-gigabyte has fallen, flash storage has become increasingly prevalent, being the underlying technology of flash drives, SD cards, the non-volatile storage unit of smartphones and tablets, among others. And in the last decade, flash storage has become increasingly prominent in PCs and servers in the form of SSDs.

SSDs are, in common usage, secondary storage units based on flash technology. Technically referring to any secondary storage unit that does not involve mechanically moving components like HDDs, SSDs are made using flash technology. As such, SSDs do not face the mechanical limitations encountered by HDDs. SSDs have many of the same advantages over HDDs as flash storage such as having significantly higher speeds and much lower latencies. However, SSDs have several special characteristics that can lead to a degradation in system performance if not properly managed. In particular, SSDs must perform a process known as garbage collection before the SSD can overwrite any previously written data. The process of garbage collection can be resource intensive, degrading an SSD's performance.

The need to perform garbage collection is a limitation of the architecture of SSDs. As a basic overview, SSDs are made using floating gate transistors, strung together in strings. Strings are then laid next to each other to form two dimensional matrices of floating gate transistors, referred to as blocks. Running transverse across the strings of a block (so including a part of every string), is a page. Multiple blocks are then joined together to form a plane, and multiple planes are formed together to form a NAND die of the SSD, which is the part of the SSD that permanently stores data. Blocks and pages are typically conceptualized as the building blocks of an SSD, because pages are the smallest unit of data which can be written to and read from, while blocks are the smallest unit of data that can be erased.

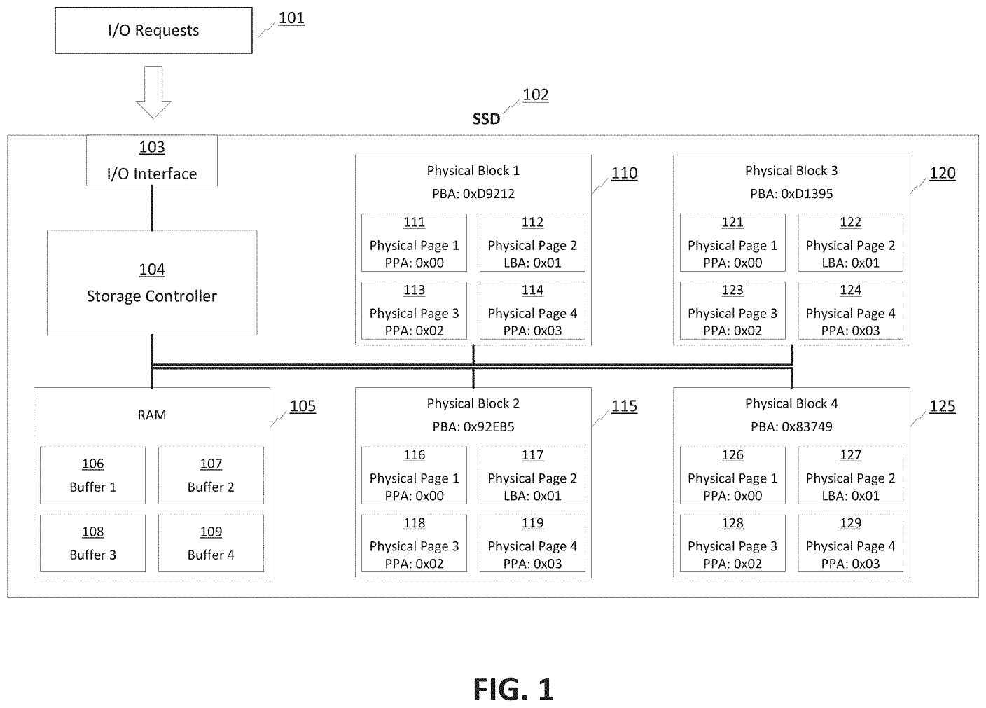

FIG. 1 is an example schematic illustrating a basic layout of an SSD, according to some embodiments of the present disclosure. As shown in FIG. 1, an SSD 102 comprises an I/O interface 103 through which the SSD communicates to a host system via input-output (“I/O”) requests 101. Connected to the I/O interface 103 is a storage controller 104, which includes processors that control the functionality of the SSD. Storage controller 104 is connected to RAM 105, which includes multiple buffers, shown in FIG. 1 as buffers 106, 107, 108, and 109. Storage controller 104 and RAM 105 are connected to physical blocks 110, 115, 120, and 125. Each of the physical blocks has a physical block address (“PBA”), which uniquely identifies the physical block. Each of the physical blocks includes physical pages. For example, physical block 110 includes physical pages 111, 112, 113, and 114. Each page also has its own physical page address (“PPA”), which is unique within its block. Together, the physical block address along with the physical page address uniquely identifies a page—analogous to combining a 7-digit phone number with its area code. Omitted from FIG. 1 are planes of blocks. In an actual SSD, a storage controller is connected not to physical blocks, but to planes, each of which is composed of physical blocks. For example, physical blocks 110, 120, 115, and 125 can be on a sample plane, which is connected to storage controller 104.

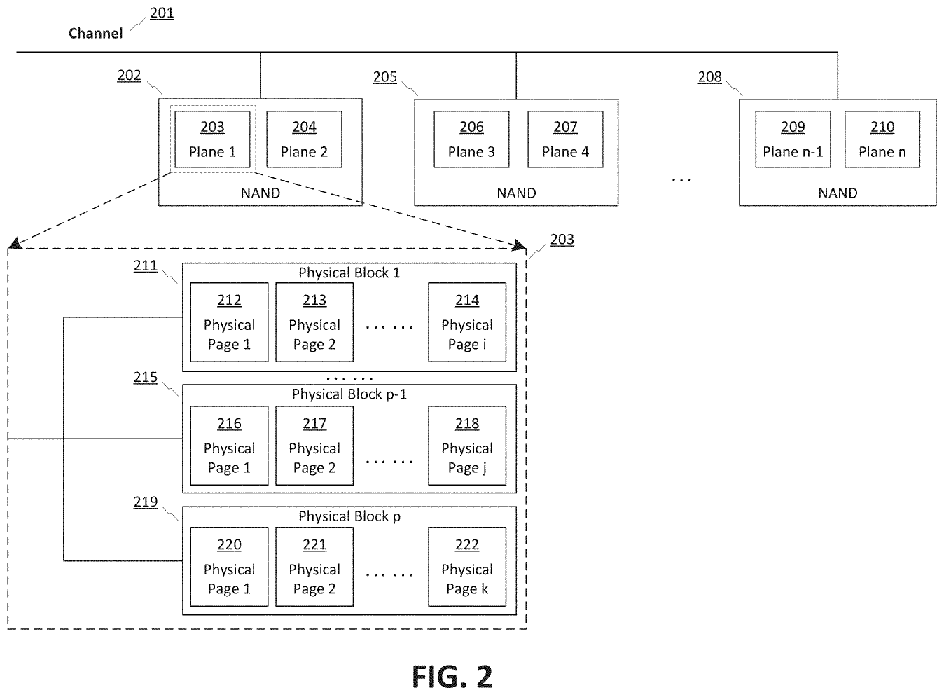

FIG. 2 is an illustration of an exemplary internal NAND flash structure of an SSD, according to some embodiments of the present disclosure. As stated above, a storage controller (e.g., storage controller 104 of FIG. 1) of an SSD is connected with one or more NAND flash integrated circuits (“ICs”), which is where data received by the SSD is ultimately stored. Each NAND IC 202, 205, and 208 typically comprises one or more planes. Using NAND IC 202 as an example, NAND IC 202 comprises planes 203 and 204. As stated above, each plane comprises one or more physical blocks. For example, plane 203 comprises physical blocks 211, 215, and 219. Each physical block comprises one or more physical pages, which, for physical block 211, are physical pages 212, 213, and 214.

An SSD typically stores a single bit in a transistor using the voltage level present (high or ground) to indicate a 0 or 1. Some SSDs also store more than one bit in a transistor using more voltage levels to indicate more values (e.g., 00, 01, 10, and 11 for two bits). Assuming an SSD stores only a single bit for simplicity, an SSD can write a 1 (e.g., can set the voltage of a transistor to high) to a single bit in a page. An SSD cannot write a zero (e.g., cannot set the voltage of a transistor to low) to a single bit in a page. Rather, an SSD can write a zero on a block-level. In other words, to set a bit of a page to zero, an SSD can set every bit of every page within a block to zero. By setting every bit to zero, an SSD can ensure that, to write data to a page, the SSD needs to only write a 1 to the bits as dictated by the data to be written, leaving untouched any bits that are set to zero (since they are zeroed out and thus already set to zero). This process of setting every bit of every page in a block to zero to accomplish the task of setting the bits of a single page to zero is known as garbage collection, since what typically causes a page to have non-zero entries is that the page is storing data that is no longer valid (“garbage data”) and that is to be zeroed out (analogous to garbage being “collected”) so that the page can be re-used.

Further complicating the process of garbage collection, however, is that some of the pages inside a block that are to be zeroed out may be storing valid data—in a worst case, all of the pages inside the block except the page needing to be garbage collected are storing valid data. Since the SSD needs to retain valid data, before any of the pages with valid data can be erased, the SSD (usually through its storage controller) needs to transfer each valid page's data to a new page in a different block. Transferring the data of each valid page in a block is a resource intensive process, as the SSD's storage controller transfers the content of each valid page to a buffer and then transfers content from the buffer into a new page. Only after the process of transferring the data of each valid page is finished may the SSD then zero out the original page (and every other page in the same block). As a result, in general the process of garbage collection involves reading the content of any valid pages in the same block to a buffer, writing the content in the buffer to a new page in a different block, and then zeroing-out every page in the present block.

The impact of garbage collection on an SSD's performance is further compounded by two other limitations imposed by the architecture of SSDs. The first limitation is that only a single page of a block may be read at a time. Only being able to read a single page of a block at a time forces the process of reading and transferring still valid pages to be done sequentially, substantially lengthening the time it takes for garbage collection to finish. The second limitation is that only a single block of a plane may be read at a time. For the entire duration that the SSD is moving these pages—and then zeroing out the block—no other page or block located in the same plane may be accessed.

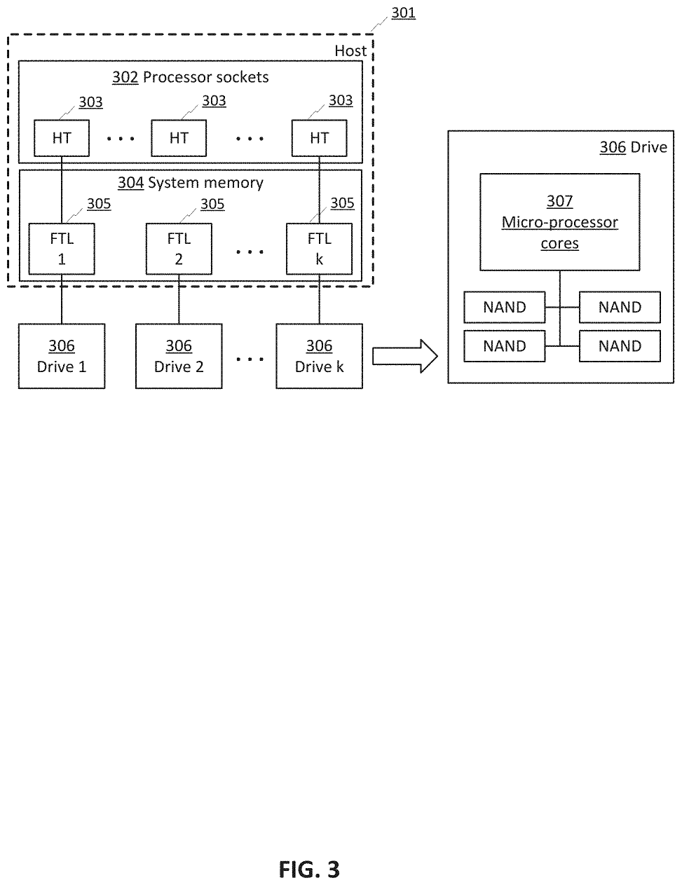

Referring back to FIG. 1, SSD 102 can be connected to a host system. For example, SSD 102 can be connected to a host system via I/O interface 103. Drives can be host managed drives, such as host-based flash translation layer (“FTL”) SSD and host-managed shingled magnetic recording (“SMR”) HDD. Implementing FTLs in a host is a typical design choice for open-channel SSDs. The SMR HDD is similar to the NAND flash SSD in the aspect of block-wise write. However, host-managed SMR HDD can also be configured as conventional magnetic recording (“CMR”) HDD, and CMR HDD can be managed by the host-side software for data placement and mapping. FIG. 3 is an illustration of an exemplary host-based flash translation layer SSD with host resource utilization, according to some embodiments of the present disclosure. As shown in FIG. 3, host 301 comprises processor sockets 302 and system memory 304. Processor sockets 302 can be configured as CPU sockets. Processor sockets 302 can comprise one or more HTs 303. System memory 304 can comprise one or more FTLs 305. In a server equipped with multiple drives (e.g., drives 306), each drive can launch its own FTL in the host (e.g., host 301). For example, Drive 1 shown in FIG. 3 can launch its own FTL 1 as a part of host 301 and claim a part of system memory 304. Meanwhile, the SSD shown in FIG. 3 (e.g., drive 306) still executes simplified firmware for tasks such as NAND media management and error handling. As a result, microprocessor cores in the SSD (e.g., micro-processor cores 307) are still needed.

There are a number of issues with the SSD designs shown in FIG. 3. First, the host-based FTL inherits conventional mapping tables between logic block address (“LBA”) and PBA. The mapping tables are stored on the host side (e.g., FTL 305 or system memory 304 of FIG. 3), which can lead to a high usage of memory space on the host. For example, if every 4 kB of memory needs to take up one entry in the mapping table, with each entry taking up 4 bytes of memory, an SSD with 4 TB of memory can result in 4 GB of mapping table memory. If there are 15 SSDs, the mapping table for the 15 SSDs can take up 60 GB of memory, which is significant for the host system. Second, the consumption of host processor resources (e.g., CPUs) for SSD is not optimal. For example, CPU cores based on the x86 architecture are powerful, but very expensive. As a result, these CPU cores could be used for more important processing tasks.

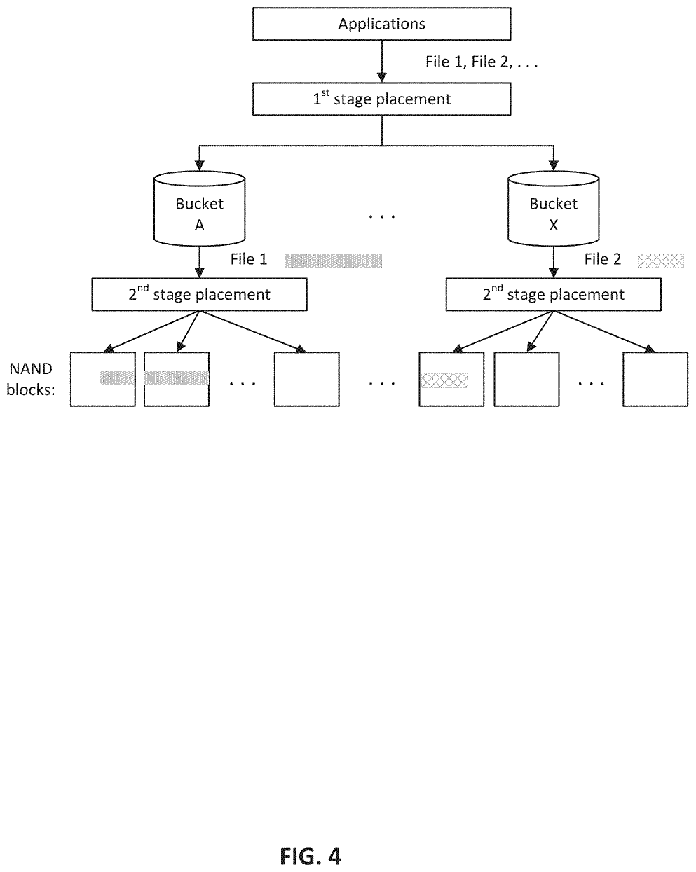

Embodiments of the present disclosure provide a two-stage data placement to mitigate the issues discussed above. FIG. 4 is an illustration of an exemplary diagram of two-stage data placement, according to some embodiments of the present disclosure. As shown in FIG. 4, in some embodiments, applications can tag files based on estimated access frequency. In the first stage placement, a host (e.g., host 301 of FIG. 3) can place different files into multiple data buckets. In some embodiments, each of the multiple data buckets can comprise one or more NAND blocks. A data bucket in the multiple data buckets can be a physical unit of storage media, and a data bucket can be erased together. In some embodiments, files in one data bucket are expected to possess similar data hotness. For example, data hotness can refer to the frequency that data is updated or accessed. As a result, garbage collection can be triggered less frequently, reducing write amplification. For example, as shown in FIG. 4, file 1 and file 2 from the applications have different data hotness. Data in file 1 is updated more frequently than data in file 2. As a result, file 1 is assigned to bucket A, and file 2 is assigned to bucket X.

In some embodiments, data hotness can be determined by the frequency of access. In some embodiments, writing access is more important that reading access. In some embodiments, data hotness can be determined by the application that hosts the data (e.g., applications of FIG. 4) or the host (e.g., host 301 of FIG. 3).

As shown in FIG. 4, the second stage placement assigns a NAND space in the data bucket to accommodate the incoming files. For example, second stage placement can place file 1 shown in FIG. 4 into two NAND blocks. In addition, second stage placement can place file 2 shown in FIG. 4 into a NAND block that is different from the two NAND blocks that hosts data in file 1. Since data in file 1 and file 2 have different data hotness, garbage collection for the NAND block hosting data in file 2 can be conducted less frequently than the garbage collection for the NAND blocks hosting data in file 1, hence making garbage collection a more efficient process.

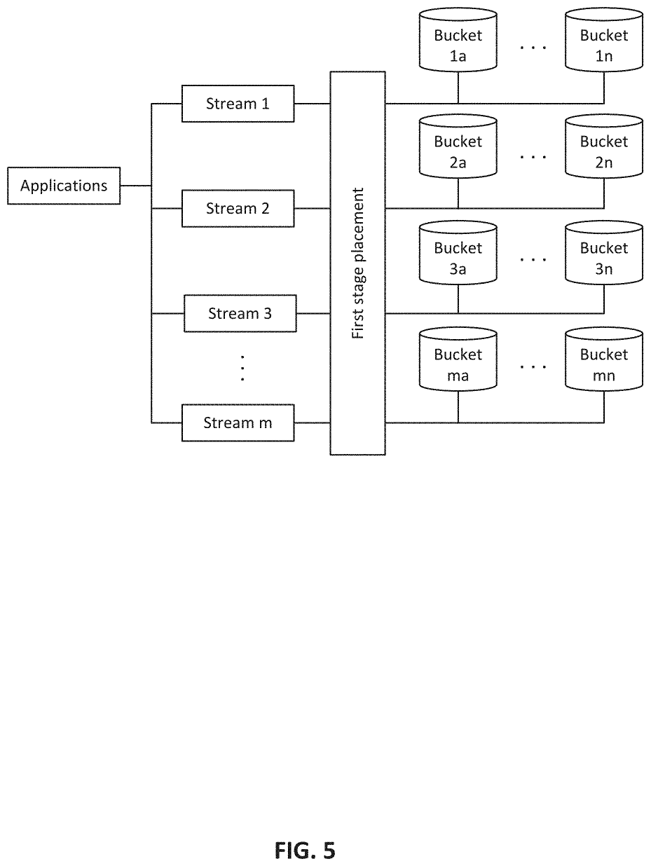

In some embodiments, based on file and client characteristics, applications or the host are able to tag files with estimated access frequency, and files are assigned into one or more streams. In some embodiments, it can be assumed that the files in the same stream can have similar lifespans. For example, applications or the host can determine the data hotness for the files, and files with similar data hotness can be placed in the same stream. As a result, the write amplification can be mitigated from the less frequently triggered garbage collection and less amount of internal data copy. FIG. 5 is an illustration of an example diagram of multiple streams with data hotness, according to some embodiments of the present disclosure. As shown in FIG. 5, applications have files that can be divided into different streams, namely stream 1 to stream m. First stage placement shown in FIG. 5 can assign files in a stream into different buckets. For example, first stage placement can assign files in stream 1 into buckets 1a to 1n, according to the file or client characteristics. Since files in different streams (e.g., stream 1 to stream m) have different data hotness, garbage collection for the buckets hosting different files can be conducted with different frequency, hence making garbage collection a more efficient process. In some embodiments, first stage placement shown in FIG. 5 is similar to first stage placement shown in FIG. 4.

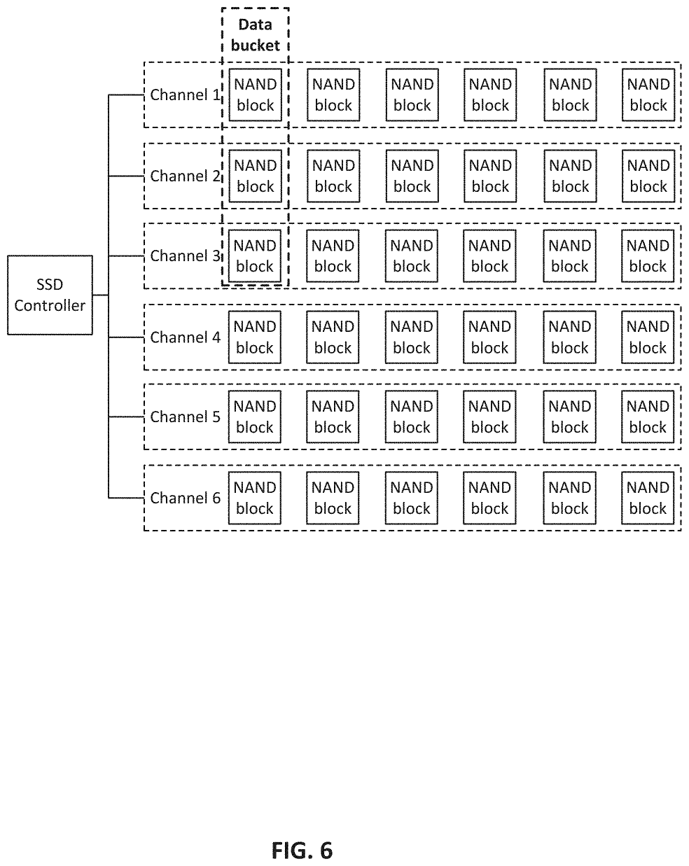

In some embodiments, NAND blocks in a channel may only be accessed one at a time. As a result, to enable parallel access, one data bucket can include NAND blocks from multiple channels. FIG. 6 is an illustration of an example diagram of multiple channels in an SSD, according to some embodiments of the present disclosure. As shown in FIG. 6, an SSD controller (e.g., storage controller 104 of FIG. 1) can fan out several channels to operate the NAND flash blocks. A data bucket (e.g., data buckets shown in FIG. 4 and FIG. 5) can comprise multiple NAND blocks across different channels. For example, the data bucket shown in FIG. 6 comprises NAND blocks from channel 1, channel 2, and channel 3. In some embodiments, a data bucket can partition the NAND geometry in a direction orthogonal to the channels. As a result, the data bucket can enable throughput parallelism by initiating concurrent access across multiple channels, hence improving access and update efficiency for data in a data bucket. In some embodiments, the channels can operate NAND flash blocks in one direction.

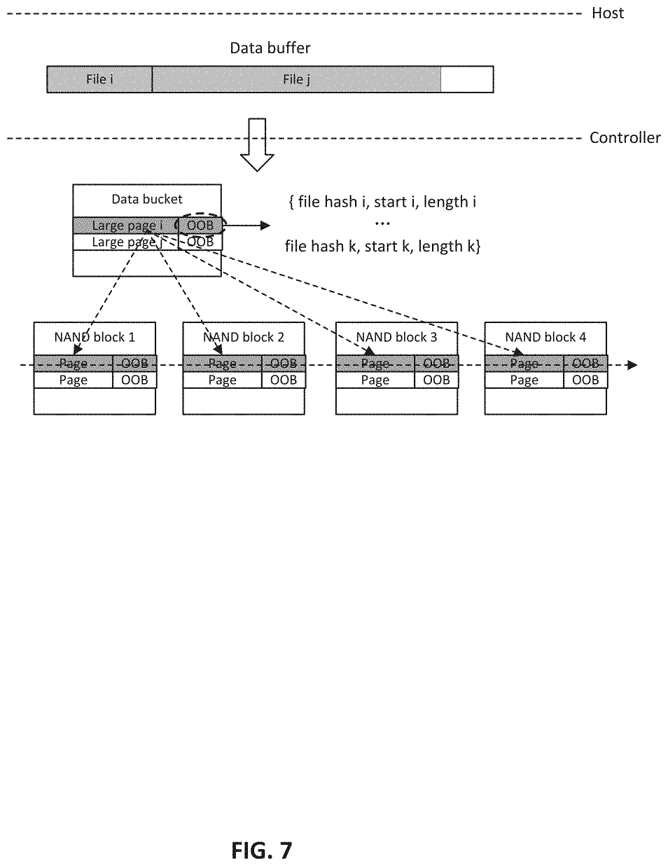

Referring back to FIG. 4, the second stage placement can divide a file in a bucket into one or more NAND blocks. In some embodiments, one data bucket can comprise one or more NAND blocks of the same size. Within each NAND block, its programming sequence can be determined. As a result, a large page can be formed by taking one or more NAND pages from one or more individual blocks. FIG. 7 is an illustration of an example diagram of a second stage of mapping, according to some embodiments of the present disclosure. As shown in FIG. 7, a data buffer in a controller (e.g., storage controller 104 of FIG. 1 or SSD controller of FIG. 6) can include one or more files, namely file i, file j, etc. When the files are placed into data buckets, they can be organized into large pages. For example, large page i shown in FIG. 7 can comprise file i and file j. In some embodiments, a large page in a data bucket can also have a corresponding out-of-band (“OOB”) region. The OOB region can store second stage mapping information, including physical locations of one file in the corresponding large page. In some embodiments, the OOB region can also store a file's hash value, start location in the large file, and the file's length. For example, as shown in FIG. 7, the OOB region for large page i includes file i's file hash, start location, and length.

In some embodiments, a file can occupy more than one large page. As a result, the file can be written into consecutive physical large pages. In some embodiments, a file can occupy more than one data bucket. As a result, the file can be partitioned ahead at the application level (e.g., first stage placement) into several sub-files. In some embodiments, each sub-file can occupy a data bucket.

Referring back to FIG. 7, a large page in a data bucket can be assigned to one or more NAND blocks. For example, large page i shown in FIG. 7 can be stored into NAND blocks 1 to 4. Each of the NAND blocks can include a NAND page that stores data in the large page. In some embodiments, a NAND page can be a sub-page of the large page. In some embodiments, the NAND blocks shown in FIG. 7 are similar to the physical blocks shown in FIG. 2, and the NAND pages shown in FIG. 7 are similar to the physical pages shown in FIG. 2. In some embodiments, a NAND page can also have a corresponding OOB region. The OOB region for the NAND page can store second stage mapping information for the page. For example, the OOB region for the NAND page can store the page's location information in the large page. The OOB region can also store information including error correction coding (“ECC”) parity, cyclic redundancy check (“CRC”) signature, logical block addressing (“LBA”), etc. In some embodiments, information stored in OOB can be read out together with the data in the physical page. For example, the controller can use ECC parity to decode error-free data, use CRC signature to ensure data consistency, or use LBA to maintain logical address to physical address mapping. Since data in a large page can be stored in a number of NAND pages across a number of NAND blocks, the NAND pages can be read or accessed concurrently, similar to the NAND blocks in the data bucket shown in FIG. 6.

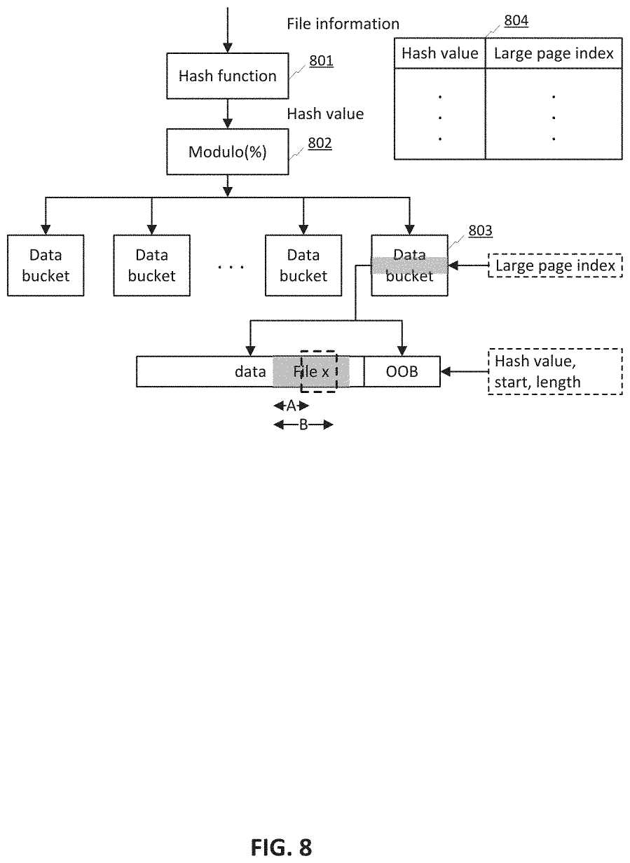

FIG. 8 is an illustration of an example diagram of a first stage and a second stage of file placement and access using hash functions, according to some embodiments of the present disclosure. As shown in FIG. 8, a file can comprise file information, such as file name, creation time, file owner, file directory, etc. In some embodiments, file information can be used to uniquely identify the file. The file information can be used as input into a hash function 801 to obtain a unique hash value. The unique hash value can be used as input into a modulo operation 802 to determine a data bucket to store the file. In some embodiments, the file can be appended behind a current write pointer in the determined data bucket. The meta data for the file, which can include the file's hash value, start location, and length, can be written into the OOB region in the data bucket. In some embodiments, similar to the data bucket shown in FIG. 7, the OOB region corresponds to large page that stores the file.

In some embodiments, the file can be too large to be accommodated by the available space of the data bucket. As a result, the second stage placement can notify the first stage placement, and the application can assign more information to generate a new hash value in the first stage and try another data bucket. This process can be repeated until a suitable data bucket is found. In some embodiments, this process operates on an assumption that the file size is smaller than the data bucket size, and one empty data bucket can end the process.

To read data in a file, the file's file information can be used to determine a unique hash value, and the unique hash value can be used in the modulo operation 802 to determine the data bucket that stores the file. In some embodiments, as shown in FIG. 8, the first stage can maintain a mapping table 804. The mapping table can include mapping information between hash values and large page indices. As a result, the system can retrieve the large page index for the file by looking up the unique hash value on mapping table 804. In some embodiments, the NAND physical address to read can be obtained through the concatenation of stream ID, the data bucket ID, and the large page index. When the large page index is read, the start location and the length of the requested file can be determined. As a result, the requested file can be loaded from the read data. In some embodiments, the application may just request part of the file. From the start and the end of the requested portion, the desired data can be truncated and sent to the host. The rest of the large page can be held in the read cache and may be retired later.

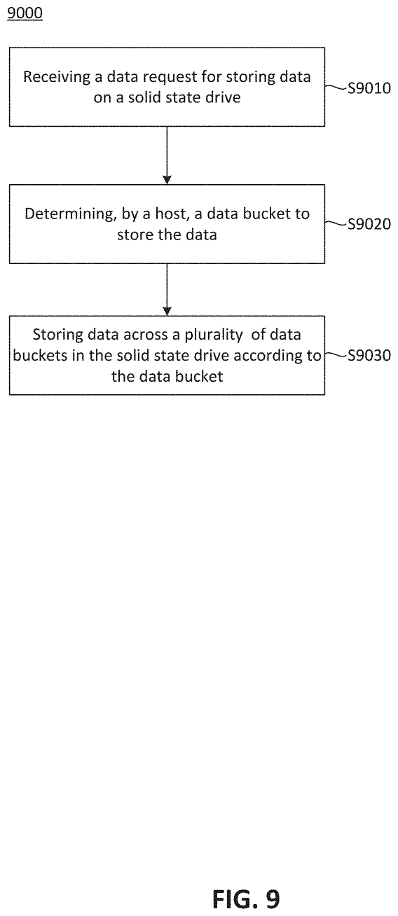

Embodiments of the present disclosure further provides a method for storing data in a host-based SSD using two stage placements. FIG. 9 is an illustration of an example method for storing data in a host-based SSD using two stage placements, according to some embodiments of the present disclosure. It is appreciated that method 9000 of FIG. 9 can be executed on the host-drive system shown in FIG. 3.

In step S9010, a data request is received for storing data on a SSD. In some embodiments, the data request can be received from an application (e.g., application of FIG. 4) running on a host system (e.g., host 301 of FIG. 3). In some embodiments, the data request can be received from an operating system running on the host system. In some embodiments, the SSD is communicatively coupled to the host system.

In step S9020, a data bucket is determined, by the host, to store the data. In some embodiments, the data bucket is similar to the buckets of FIG. 4 or FIG. 5, or the data buckets of FIG. 6 or FIG. 7. In some embodiments, the data buckets comprises a plurality of data blocks in the SSD, similar to NAND blocks in FIG. 4, FIG. 6, and FIG. 7. In some embodiments, the plurality of data blocks are spread across different data channels (e.g., channels of FIG. 6) on the SSD, so that data can be stored into the plurality of data blocks in parallel.

In some embodiments, the data bucket is determined according to the data hotness of the data. For example, as shown in FIG. 4, file 1 and file 2 from the applications have different data hotness. Data in file 1 is updated more frequently than data in file 2. As a result, file 1 is assigned to bucket A, and file 2 is assigned to bucket X. In some embodiments, data hotness can be determined by an application running on the host. For example, as shown in FIG. 5, applications have files that can be divided into different streams, where files in different streams (e.g., stream 1 to stream m) can have different data hotness. As a result, garbage collection for the buckets hosting different files can be conducted with different frequency, hence making garbage collection a more efficient process.

In some embodiments, the data bucket can be determined according to hash functions. For example, as shown in FIG. 8, file information can be used as input to a hash function to generate a unique hash value, and the hash value can be used determine the data bucket to store the data.

Referring back to FIG. 9, in step S9030, the data is stored across the plurality of data blocks. In some embodiments, when data is placed into data buckets, it can be organized into a large page. For example, large page i shown in FIG. 7 can comprise file i and file j. In some embodiments, a large page in a data bucket can also have a corresponding OOB region, similar to the OOB region corresponding to the large page in FIG. 7. The OOB region can store second stage mapping information, including physical locations of one file in the corresponding large page. In some embodiments, the OOB region can also store a file's hash value, start location in the large file, and the file's length. For example, as shown in FIG. 7, the OOB region for large page i includes file i's file hash, start location, and length.

In some embodiments, the large page comprises a plurality of pages stored across a plurality of blocks, similar to the pages shown in FIG. 7. The data can be stored across the plurality of pages. In some embodiments, the plurality of pages can also have an OOB region, similar to the OOB regions corresponding to the pages shown in FIG. 7. The OOB region can store second stage mapping information for the page. For example, as shown in FIG. 7 the OOB region for the NAND page can store the page's location information in the large page. Since data in a large page can be stored in a number of NAND pages across a number of NAND blocks, the NAND pages can be read or accessed concurrently, improving efficiency of garbage collection.

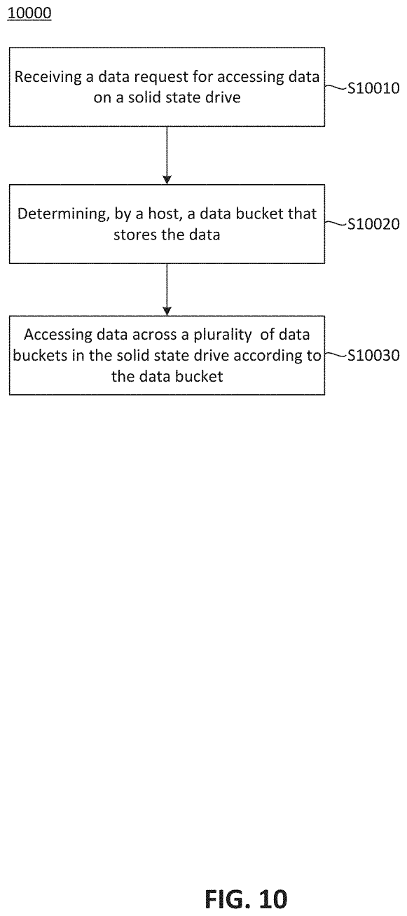

Embodiments of the present disclosure further provides a method for accessing data in a host-based SSD using two stage placements. FIG. 10 is an illustration of an example method for accessing data in a host-based SSD using two stage placements, according to some embodiments of the present disclosure. It is appreciated that method 10000 of FIG. 10 can be executed on the host-drive system shown in FIG. 3.

In step S10010, a data request is received for accessing data on an SSD. In some embodiments, the data request can be received from an application (e.g., application of FIG. 4) running on a host system (e.g., host 301 of FIG. 3). In some embodiments, the data request can be received from an operating system running on the host system. In some embodiments, the SSD is communicatively coupled to the host system.

In step S10020, a data bucket is determined, by the host, that stores the data. In some embodiments, the data bucket is similar to the buckets of FIG. 4 or FIG. 5, or the data buckets of FIG. 6 or FIG. 7. In some embodiments, the data buckets comprises a plurality of data blocks in the SSD, similar to NAND blocks in FIG. 4, FIG. 6, and FIG. 7. In some embodiments, the plurality of data blocks are spread across different data channels (e.g., channels of FIG. 6), and the data is stored into the plurality of data blocks and can be accessed in parallel.

In some embodiments, the data bucket is determined according to the data hotness of the data. For example, as shown in FIG. 4, file 1 and file 2 from the applications have different data hotness. Data in file 1 is updated more frequently than data in file 2. As a result, file 1 is stored and can be accessed in bucket A, and file 2 is stored and can be accessed in bucket X. In some embodiments, data hotness can be determined by an application running on the host. For example, as shown in FIG. 5, applications have files that are divided into different streams, where files in different streams (e.g., stream 1 to stream m) can have different data hotness. As a result, garbage collection for the buckets hosting different files can be conducted with different frequency, hence making garbage collection a more efficient process.

In some embodiments, the data bucket can be determined according to hash functions. For example, as shown in FIG. 8, file information can be used as input to a hash function to generate a unique hash value, and the hash value can be used determine the data bucket that stores the data.

Referring back to FIG. 10, in step S10030, the data is accessed across the plurality of data blocks. In some embodiments, data stored in data buckets can be organized into a large page. For example, large page i shown in FIG. 7 can comprise file i and file j. In some embodiments, a large page in a data bucket can also have a corresponding OOB region, similar to the OOB region corresponding to the large page in FIG. 7. The OOB region can be accessed to assist in accessing the data. For example, the OOB region can store second stage mapping information, including physical locations of one file in the corresponding large page. In some embodiments, the OOB region can also store a file's hash value, start location in the large file, and the file's length. For example, as shown in FIG. 7, the OOB region for large page i includes file i's file hash, start location, and length.

In some embodiments, the large page comprises a plurality of pages stored across a plurality of blocks, similar to the pages shown in FIG. 7. The data can be stored across the plurality of pages. In some embodiments, the plurality of pages can also have an OOB region, similar to the OOB regions corresponding to the pages shown in FIG. 7. The OOB region can be accessed to assist in accessing the data. For example, the OOB region can store second stage mapping information for the page. For example, as shown in FIG. 7 the OOB region for the NAND page can store the page's location information in the large page. Since data in a large page can be stored in a number of NAND pages across a number of NAND blocks, the NAND pages can be read or accessed concurrently, improving efficiency of garbage collection.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The host system, operating system, file system, and other functional units described in this disclosure can be implemented by hardware, or software, or a combination of hardware and software. One of ordinary skill in the art will also understand that multiple ones of the above described functional units may be combined as one functional unit, and each of the above described functional units may be further divided into a plurality of functional sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

The embodiments may further be described using the following clauses:

1. A method, comprising:

receiving a data request for storing data on a storage device, wherein the data request is received on a host that is communicatively coupled to the storage device;

determining, by the host, a data bucket to store the data, wherein the data bucket comprises a plurality of data blocks in the storage device, and the plurality of data blocks belong to more than one channel in the storage device; and

storing the data across the plurality of data blocks.

2. The method of clause 1, wherein determining, by the host, a data bucket to store the data further comprising:

determining data hotness for the data, and

determining the data bucket to store the data according to the data hotness.

3. The method of clause 2, wherein:

determining data hotness for the data further comprising:
determining, by an application running on the host, a data stream from a plurality of data streams according to the data hotness; and

determining a data bucket to store the data according to the data hotness further comprising:
determining the data bucket corresponding to the data stream to store the data.

4. The method of any one of clauses 1-3, wherein determining, by the host, a data bucket to store the data further comprising:

determining file information corresponding to the data;

determining a hash value corresponding to the file information according to a hash function; and

determining the data bucket to store the data according to the hash value.

5. The method of clause 4, wherein storing the data across the plurality of data blocks further comprising:

organizing the data into a page that is assigned to the plurality of data blocks and that comprises a plurality of sub-pages in the plurality of data blocks, wherein the storage device is a solid-state drive; and

storing the data across the plurality of sub-pages.

6. The method of clause 5, further comprising:

storing mapping information of the data in an out-of-band region that corresponds to the page, wherein the mapping information includes location information of the data in the page.

7. The method of clause 5, further comprising:

storing mapping information of the data in an out-of-band region that corresponds to one of the plurality of sub-pages, wherein the mapping information includes location information of the data in the sub-pages.

8. A method, comprising:

receiving a data request for accessing data on a storage device, wherein the data request is received on a host that is communicatively coupled to the storage device;

determining, by the host, a data bucket that stores the data, wherein the data bucket comprises a plurality of data blocks in the storage device, and the plurality of data blocks belong to more than one channel in the storage device; and

accessing the data across the plurality of data blocks.

9. The method of clause 8, wherein determining, by the host, a data bucket that stores the data further comprising:

determining data hotness for the data, and

determining the data bucket that stores the data according to the data hotness.

10. The method of clause 9, wherein:

determining data hotness for the data further comprising:
determining, by an application running on the host, a data stream from a plurality of data streams according to the data hotness; and

determining a data bucket that stores the data according to the data hotness further comprising:
determining the data bucket corresponding to the data stream to store the data.

11. The method of any one of clauses 8-10, wherein determining, by the host, a data bucket that stores the data further comprising:

determining file information corresponding to the data;

determining a hash value corresponding to the file information according to a hash function; and

determining the data bucket that stores the data according to the hash value.

12. The method of clause 11, wherein accessing the data across the plurality of data blocks further comprising:

accessing the data organized into a page that is assigned to the plurality of data blocks and that comprises a plurality of sub-pages in the plurality of data blocks; and

accessing the data across the plurality of sub-pages.

13. The method of clause 12, wherein accessing the data organized into a page further comprising:

accessing mapping information of the data in an out-of-band region that corresponds to the page, wherein the mapping information includes location information of the data in the page.

14. The method of clause 12, wherein accessing the data across the plurality of sub-pages further comprising:

accessing mapping information of the data in an out-of-band region that corresponds to one of the plurality of sub-pages, wherein the mapping information includes location information of the data in the sub-pages.

15. A non-transitory computer readable medium that stores a set of instructions that is executable by at least one processor of a computer system to cause the computer system to perform a method, the method comprising:

receiving a data request for storing data on a storage device, wherein the data request is received on a host that is communicatively coupled to the storage device;

determining, by the host, a data bucket to store the data, wherein the data bucket comprises a plurality of data blocks in the storage device, and the plurality of data blocks belong to more than one channel in the storage device; and

storing the data across the plurality of data blocks.

16. The non-transitory computer readable medium of clause 15, wherein the set of instructions is executable by the at least one processor of the computer system to cause the computer system to further perform:

determining data hotness for the data, and

determining the data bucket to store the data according to the data hotness.

17. The non-transitory computer readable medium of clause 16, wherein the set of instructions is executable by the at least one processor of the computer system to cause the computer system to further perform:

determining, by an application running on the host, a data stream from a plurality of data streams according to the data hotness; and

determining the data bucket corresponding to the data stream to store the data.

18. The non-transitory computer readable medium of any one of clauses 15-17, wherein the set of instructions is executable by the at least one processor of the computer system to cause the computer system to further perform:

determining file information corresponding to the data;

determining a hash value corresponding to the file information according to a hash function; and

determining the data bucket to store the data according to the hash value.

19. The non-transitory computer readable medium of clause 18, wherein the set of instructions is executable by the at least one processor of the computer system to cause the computer system to further perform:

organizing the data into a page that is assigned to the plurality of data blocks and that comprises a plurality of sub-pages in the plurality of data blocks, wherein the storage device is a solid-state drive; and

storing the data across the plurality of sub-pages.

20. The non-transitory computer readable medium of clause 19, wherein the set of instructions is executable by the at least one processor of the computer system to cause the computer system to further perform:

storing mapping information of the data in an out-of-band region that corresponds to the page, wherein the mapping information includes location information of the data in the page.

21. The non-transitory computer readable medium of clause 19, wherein the set of instructions is executable by the at least one processor of the computer system to cause the computer system to further perform:

storing mapping information of the data in an out-of-band region that corresponds to one of the plurality of sub-pages, wherein the mapping information includes location information of the data in the sub-pages.

22. A non-transitory computer readable medium that stores a set of instructions that is executable by at least one processor of a computer system to cause the computer system to perform a method, the method comprising:

receiving a data request for accessing data on a storage device, wherein the data request is received on a host that is communicatively coupled to the storage device;

determining, by the host, a data bucket that stores the data, wherein the data bucket comprises a plurality of data blocks in the storage device, and the plurality of data blocks belong to more than one channel in the storage device; and

accessing the data across the plurality of data blocks.

23. The non-transitory computer readable medium of clause 22, wherein the set of instructions is executable by the at least one processor of the computer system to cause the computer system to further perform:

determining data hotness for the data, and

determining the data bucket that stores the data according to the data hotness.

24. The non-transitory computer readable medium of clause 23, wherein the set of instructions is executable by the at least one processor of the computer system to cause the computer system to further perform:

determining, by an application running on the host, a data stream from a plurality of data streams according to the data hotness; and

determining the data bucket corresponding to the data stream to store the data.

25. The non-transitory computer readable medium of any one of clauses 22-24, wherein the set of instructions is executable by the at least one processor of the computer system to cause the computer system to further perform:

determining file information corresponding to the data;

determining a hash value corresponding to the file information according to a hash function; and

determining the data bucket that stores the data according to the hash value.

26. The non-transitory computer readable medium of clause 25, wherein the set of instructions is executable by the at least one processor of the computer system to cause the computer system to further perform:

accessing the data organized into a page that is assigned to the plurality of data blocks, and that comprises a plurality of sub-pages in the plurality of data blocks; and

accessing the data across the plurality of sub-pages.

27. The non-transitory computer readable medium of clause 26, wherein the set of instructions is executable by the at least one processor of the computer system to cause the computer system to further perform:

accessing mapping information of the data in an out-of-band region that corresponds to the page, wherein the mapping information includes location information of the data in the page.

28. The non-transitory computer readable medium of clause 27, wherein the set of instructions is executable by the at least one processor of the computer system to cause the computer system to further perform:

accessing mapping information of the data in an out-of-band region that corresponds to one of the plurality of sub-pages, wherein the mapping information includes location information of the data in the sub-pages.

29. A system for optimizing data storage, comprising:

a memory storing a set of instructions;

one or more processors configured to execute the set of instructions to cause the system to perform:
receiving a data request for storing data on a storage device, wherein the data request is received on a host that is communicatively coupled to the storage device;
determining, by the host, a data bucket to store the data, wherein the data bucket comprises a plurality of data blocks in the storage device, and the plurality of data blocks belong to more than one channel in the storage device; and
storing the data across the plurality of data blocks.

30. The system of clause 29, wherein the one or more processors are further configured to execute the set of instructions to cause the system to perform:

determining data hotness for the data, and

determining the data bucket to store the data according to the data hotness.

31. The system of clause 30, wherein the one or more processors are further configured to execute the set of instructions to cause the system to perform:

determining, by an application running on the host, a data stream from a plurality of data streams according to the data hotness; and

determining the data bucket corresponding to the data stream to store the data.

32. The system of any one of clauses 29-31, wherein the one or more processors are further configured to execute the set of instructions to cause the system to perform:

determining file information corresponding to the data;

determining a hash value corresponding to the file information according to a hash function; and

determining the data bucket to store the data according to the hash value.

33. The system of clause 32, wherein the one or more processors are further configured to execute the set of instructions to cause the system to perform:

organizing the data into a page that is assigned to the plurality of data blocks and that comprises a plurality of sub-pages in the plurality of data blocks, wherein the storage device is a solid-state drive; and

storing the data across the plurality of sub-pages.

34. The system of clause 33, wherein the one or more processors are further configured to execute the set of instructions to cause the system to perform:

storing mapping information of the data in an out-of-band region that corresponds to the page, wherein the mapping information includes location information of the data in the page.

35. The system of clause 33, wherein the one or more processors are further configured to execute the set of instructions to cause the system to perform:

storing mapping information of the data in an out-of-band region that corresponds to one of the plurality of sub-pages, wherein the mapping information includes location information of the data in the sub-pages.

36. A system for optimizing data storage, comprising:

a memory storing a set of instructions;

one or more processors configured to execute the set of instructions to cause the system to perform:
receiving a data request for accessing data on a storage device, wherein the data request is received on a host that is communicatively coupled to the storage device;
determining, by the host, a data bucket that stores the data, wherein the data bucket comprises a plurality of data blocks in the storage device, and the plurality of data blocks belong to more than one channel in the storage device;
accessing the data across the plurality of data blocks.

37. The system of clause 36, wherein the one or more processors are further configured to execute the set of instructions to cause the system to perform:

determining data hotness for the data, and

determining the data bucket that stores the data according to the data hotness.

38. The system of clause 37, wherein the one or more processors are further configured to execute the set of instructions to cause the system to perform:

determining, by an application running on the host, a data stream from a plurality of data streams according to the data hotness; and

determining the data bucket corresponding to the data stream to store the data.

39. The system of any one of clauses 36-38, wherein the one or more processors are further configured to execute the set of instructions to cause the system to perform:

determining file information corresponding to the data;

determining a hash value corresponding to the file information according to a hash function; and

determining the data bucket that stores the data according to the hash value.

40. The system of clause 39, wherein the one or more processors are further configured to execute the set of instructions to cause the system to perform:

accessing the data organized into a page that is assigned to the plurality of data blocks and that comprises a plurality of sub-pages in the plurality of data blocks; and

accessing the data across the plurality of sub-pages.

41. The system of clause 40, wherein the one or more processors are further configured to execute the set of instructions to cause the system to perform:

accessing mapping information of the data in an out-of-band region that corresponds to the page, wherein the mapping information includes location information of the data in the page.

42. The system of clause 41, wherein the one or more processors are further configured to execute the set of instructions to cause the system to perform:

accessing mapping information of the data in an out-of-band region that corresponds to one of the plurality of sub-pages, wherein the mapping information includes location information of the data in the sub-pages.

In the drawings and specification, there have been disclosed exemplary embodiments. However, many variations and modifications can be made to these embodiments. Accordingly, although specific terms are employed, they are used in a generic and descriptive sense only and not for purposes of limitation.

1. A method, comprising:
receiving a data request for storing data on a storage device, wherein the data request is received on a host that is communicatively coupled to the storage device;
determining, by the host, a data bucket to store the data, wherein the data bucket comprises a plurality of data blocks in the storage device, and the plurality of data blocks belong to more than one channel in the storage device, and wherein the determining the data bucket includes:
determining file information corresponding to the data;
determining a hash value corresponding to the file information according to a hash function; and
determining the data bucket to store the data according to the hash value; and
storing the data across the plurality of data blocks.

2. The method of claim 1, wherein determining, by the host, a data bucket to store the data further comprising:
determining data hotness for the data, and
determining the data bucket to store the data according to the data hotness.

3. The method of claim 2, wherein:
determining data hotness for the data further comprising:
determining, by an application running on the host, a data stream from a plurality of data streams according to the data hotness; and
determining a data bucket to store the data according to the data hotness further comprising:
determining the data bucket corresponding to the data stream to store the data.

4. (canceled)

5. The method of claim 1, wherein storing the data across the plurality of data blocks further comprising:
organizing the data into a page that is assigned to the plurality of data blocks and that comprises a plurality of sub-pages in the plurality of data blocks, wherein the storage device is a solid-state drive; and
storing the data across the plurality of sub-pages.

6. The method of claim 5, further comprising:
storing mapping information of the data in an out-of-band region that corresponds to the page, wherein the mapping information includes location information of the data in the page.

7. The method of claim 5, further comprising:
storing mapping information of the data in an out-of-band region that corresponds to one of the plurality of sub-pages, wherein the mapping information includes location information of the data in the sub-pages.

8. A non-transitory computer readable medium that stores a set of instructions that is executable by at least one processor of a computer system to cause the computer system to perform a method, the method comprising:
receiving a data request for storing data on a storage device, wherein the data request is received on a host that is communicatively coupled to the storage device;
determining, by the host, a data bucket to store the data, wherein the data bucket comprises a plurality of data blocks in the storage device, and the plurality of data blocks belong to more than one channel in the storage device, and wherein the determining the data bucket includes:
determining file information corresponding to the data;
determining a hash value corresponding to the file information according to a hash function; and
determining the data bucket to store the data according to the hash value; and
storing the data across the plurality of data blocks.

9. The non-transitory computer readable medium of claim 8, wherein the set of instructions is executable by the at least one processor of the computer system to cause the computer system to further perform:
determining data hotness for the data, and
determining the data bucket to store the data according to the data hotness.

10. The non-transitory computer readable medium of claim 9, wherein the set of instructions is executable by the at least one processor of the computer system to cause the computer system to further perform:
determining, by an application running on the host, a data stream from a plurality of data streams according to the data hotness; and
determining the data bucket corresponding to the data stream to store the data.

11. (canceled)

12. The non-transitory computer readable medium of claim 8, wherein the set of instructions is executable by the at least one processor of the computer system to cause the computer system to further perform:
organizing the data into a page that is assigned to the plurality of data blocks and that comprises a plurality of sub-pages in the plurality of data blocks; and
storing the data across the plurality of sub-pages.

13. The non-transitory computer readable medium of claim 12, wherein the set of instructions is executable by the at least one processor of the computer system to cause the computer system to further perform:
storing mapping information of the data in an out-of-band region that corresponds to the page, wherein the mapping information includes location information of the data in the page.

14. The non-transitory computer readable medium of claim 12, wherein the set of instructions is executable by the at least one processor of the computer system to cause the computer system to further perform:
storing mapping information of the data in an out-of-band region that corresponds to one of the plurality of sub-pages, wherein the mapping information includes location information of the data in the sub-pages.

15. A system for optimizing data storage, comprising:
a memory storing a set of instructions;
one or more processors configured to execute the set of instructions to cause the system to perform:
receiving a data request for storing data on a storage device, wherein the data request is received on a host that is communicatively coupled to the storage device;
determining, by the host, a data bucket to store the data, wherein the data bucket comprises a plurality of data blocks in the storage device, and the plurality of data blocks belong to more than one channel in the storage device, and wherein the determining the data bucket includes:
determining file information corresponding to the data;
determining a hash value corresponding to the file information according to a hash function; and
determining the data bucket to store the data according to the hash value; and
storing the data across the plurality of data blocks.

16. The system of claim 15, wherein the one or more processors are further configured to execute the set of instructions to cause the system to perform:
determining data hotness for the data, and
determining the data bucket to store the data according to the data hotness.

17. (canceled)

18. The system of claim 15, wherein the one or more processors are further configured to execute the set of instructions to cause the system to perform:
organizing the data into a page that is assigned to the plurality of data blocks and that comprises a plurality of sub-pages in the plurality of data blocks; and
storing the data across the plurality of sub-pages.

19. The system of claim 18, wherein the one or more processors are further configured to execute the set of instructions to cause the system to perform:
storing mapping information of the data in an out-of-band region that corresponds to the page, wherein the mapping information includes location information of the data in the page.

20. The system of claim 18, wherein the one or more processors are further configured to execute the set of instructions to cause the system to perform:
storing mapping information of the data in an out-of-band region that corresponds to one of the plurality of sub-pages, wherein the mapping information includes location information of the data in the sub-pages.
